(19) United States
(12) Patent Application Publication
(10) Pub. No.: US 2021/0214078 A1
(43) Pub. Date: Jul. 15, 2021

(54) TRANSPORTATION SYSTEM AND TRANSPORTATION MANAGEMENT SERVER, FLYING BODY, AND TRAVELLING BODY

(71) Applicant: TOYOTA JIDOSHA KABUSHIKI KAISHA, Toyota-shi (JP)

(72) Inventor: Tomoaki IHARA, Toyota-shi (JP)

(73) Assignee: TOYOTA JIDOSHA KABUSHIKI KAISHA, Toyota-shi (JP)

(21) Appl. No.: 17/105,702

(22) Filed: Nov. 27, 2020

(30) Foreign Application Priority Data
Jan. 15, 2020 (JP) 2020-004265

(51) Int. Cl. B64C 37/02

(52) U.S. Cl. CPC B64C 37/02

(57) ABSTRACT

A transportation system includes: a flying body that can fly along an airway and can be boarded by a person to be transported; a traveling body that can travel on a land route and can be connected to the flying body; and a transportation server that can communicate with the flying body and the traveling body. The flying body is configured to fly along the airway in the state in which it is detached from the traveling body. A flight management unit generates and acquires flight command information including a destination-side takeoff and landing site. The flight management unit dispatch, to the destination-side takeoff and landing site, the traveling body to which the flying body is not connected.

### CROSS REFERENCE TO RELATED APPLICATIONS

This application is based upon and claims the benefit of priority from Japanese patent application No. 2020-004265, filed on Jan. 15, 2020, the disclosure of which is incorporated herein in its entirety by reference.

### BACKGROUND

The present disclosure relates to a transportation system and a transportation management server, a flying body, and a traveling body.

Patent Literature 1 (Japanese Unexamined Patent Application Publication No. 2017-185866) discloses an air-ground use vehicle capable of traveling on a road like a general automobile and flying in the air.

### SUMMARY

In the air-ground use vehicle disclosed in Patent Literature 1, the flight range in an airway is short.

An object of the present disclosure is to provide a technique for increasing the flight range in an airway.

According to a first aspect of the present disclosure, a transportation system including: a flying body that can fly along an airway and can be boarded by a person who is to be transported; a traveling body that can travel on a land route and can be connected to the flying body; and a transportation management server that can communicate with the flying body and the traveling body, in which the traveling body is configured to be able to travel on the land route in a state in which the flying body is connected to the traveling body and in a state in which the traveling body is detached from the flying body, the flying body is configured to fly along the airway in the state in which it is detached from the traveling body, and the transportation management server includes: a flight information acquiring unit configured to acquire flight information including a planned landing place of the flying body; and a planned landing place vehicle dispatch unit configured to dispatch, to the planned landing place, the traveling body to which the flying body is not connected is provided. According to the above configuration, the flight range in the airway is increased.

The transportation management server may further include a departure information acquisition unit configured to acquire departure information including information on a departure place of the person who is to be transported; and a departure place vehicle dispatch unit configured to dispatch, to the departure place, the traveling body to which the flying body is connected. According to the above configuration, the person who is to be transported is able to get on the flying body without changing vehicles.

The traveling body may travel from the departure place to a planned takeoff place of the flying body in the state in which the flying body is connected to the traveling body. According to the above configuration, the traveling body is able to travel to a suitable planned takeoff place.

The traveling body may travel from the planned landing place to the destination of the person who is to be transported in the state in which the flying body is connected to the traveling body. According to the above configuration, the person who is to be transported is able to arrive at the destination without changing vehicles.

The traveling body may be able to autonomously travel on the land route.

The flying body may be able to autonomously fly along the airway.

The flying body may be configured in such a way that it is driven by a battery that can be charged, the traveling body may be configured to be able to charge the battery of the flying body in a state in which the traveling body is connected to the flying body, the flight information may include information on a planned temporary landing place where the flying body temporarily lands in order to charge the battery of the flying body, the planned temporary landing place may be a place between the departure place of the person who is to be transported and the planned landing place, and the transportation system may further include a planned temporary landing place vehicle dispatch unit configured to dispatch, to the planned temporary landing place, the traveling body to which the flying body is not connected. According to the above configuration, the flight range of the flying body can be substantially extended.

The traveling body may travel from the planned temporary landing place to the destination of the person who is to be transported while charging the battery of the flying body. According to the above configuration, it is possible to bring the traveling body close to the destination of the person who is to be transported using the charging time.

According to a second aspect of the present disclosure, a transportation management server that can communicate with a flying body that can fly along an airway and that can be boarded by a person who is to be transported and a traveling body that can travel on a land route and that can be connected to the flying body, in which the traveling body is configured to be able to travel on the land route in a state in which the flying body is connected to the traveling body and in a state in which the traveling body is detached from the flying body, the flying body is configured to fly along the airway in the state in which it is detached from the traveling body, the transfer management server includes a flight information acquiring unit configured to acquire flight information including a planned landing place of the flying body, and the transfer management server includes a planned landing place vehicle dispatch unit configured to dispatch, to the planned landing place, the traveling body to which the flying body is not connected. According to the above configuration, the flight range in the airway is increased.

According to a third aspect of the present disclosure, a flying body including a connecting unit that can be connected to a traveling body capable of traveling on a land route and communicating with a transportation management server and a communication unit that can communicate with the transportation management server, the flying body being able to fly along an airway with a person who is to be transported on board, in which the communication unit transmits, to the transportation management server, a planned landing place where the flying body is planned to land after the flight in a state in which it is not connected to the traveling body, and the connecting unit is connected to the traveling body after the flight to the planned landing place.

According to a fourth aspect of the present disclosure, a traveling body that can be connected to a flying body capable of communicating with a transportation management server and flying along an airway with a person who is to be transported on board, the traveling body being capable of traveling on a land route in a state in which the flying body is connected to the traveling body and in a state in which the traveling body is detached from the flying body, and the traveling body including a communication unit that can communicate with the transportation management server, in which the traveling body further includes a control unit configured to control traveling of the traveling body based on flight information from the communication unit, the flight information includes information on a planned landing place where the flying body detached from the traveling body is planned to land, the communication unit acquires the flight information from the transportation management server, and the control unit causes the traveling body to travel to the planned landing place based on the flight information.

According to the present disclosure, the flight range in the airway is increased.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view of a next-generation taxi;

FIG. 2 is a perspective view showing a state in which a flying body takes off from a traveling body or lands on the traveling body;

FIG. 3 is a functional block diagram of a transportation system;

FIG. 4 is a control flow of the transportation system (first embodiment);

FIG. 5 is a control flow of a transportation system (second embodiment); and

FIG. 6 is a control flow of the transportation system (second embodiment).

### DESCRIPTION OF EMBODIMENTS

### First Embodiment

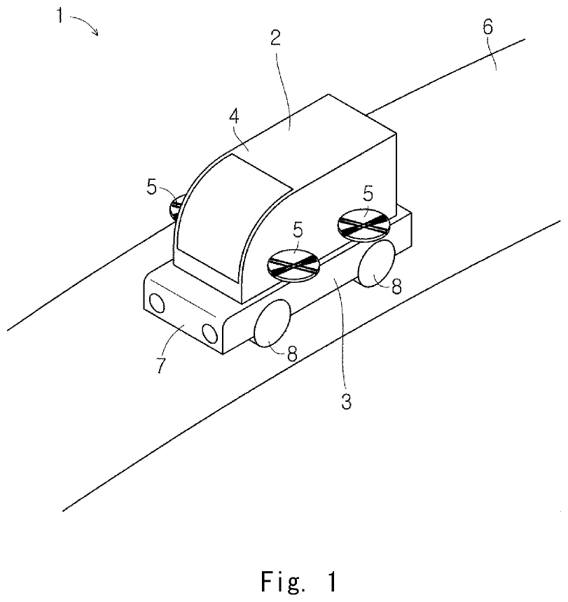

Hereinafter, with reference to FIGS. 1 to 4, a first embodiment of the present disclosure will be described.

FIG. 1 shows a next-generation taxi 1. The next-generation taxi 1, which is one specific example of a next-generation mobile body, is a component for achieving a next-generation transportation service. The next-generation taxi 1 is formed of a flying body 2 and a traveling body 3.

The flying body 2, which is able to autonomously fly along a desired airway, is configured in such a way that a user (person who is to be transported) can get on the flying body 2. Specifically, the flying body 2 includes at least a cabin 4 that provides a space for allowing the user to get on the flying body 2, a plurality of propellers 5 for lifting up the cabin 4 and moving the cabin 4 horizontally in the air, and a motor (not shown) that rotationally drives the plurality of propellers 5. The flying body 2 further includes a connecting unit 2a. The connecting unit 2a is a part that can be connected to the traveling body 3.

The traveling body 3 is able to travel on a land route 6 and can be connected to the flying body 2. Specifically, the traveling body 3 includes a main body 7 on which the flying body 2 can be mounted, a plurality of wheels 8 attached to the main body 7, and a motor (not shown) that rotationally drives the plurality of wheels 8. The land route 6 includes a paved road or an unpaved road. The main body 7 of the traveling body 3 is configured in such a way that it can be connected to the connecting unit 2a of the flying body 2.

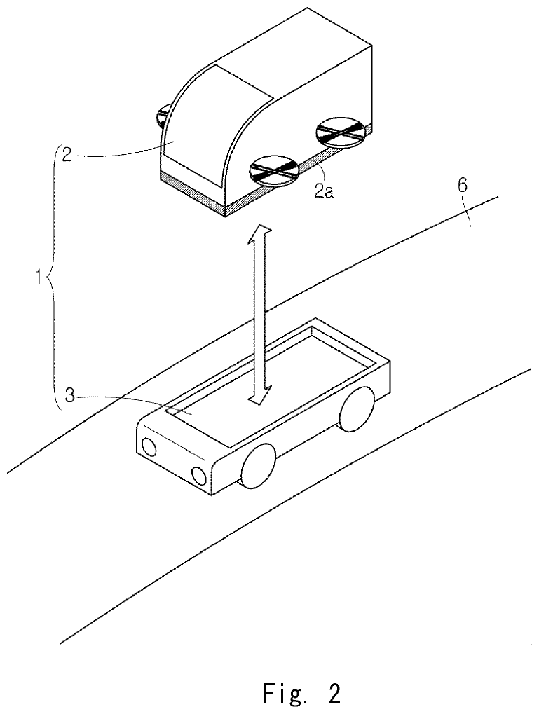

FIG. 2 shows a state in which the flying body 2 is connected to the traveling body 3 and is detached from the traveling body 3.

The traveling body 3 is configured to be able to travel on the land route 6 in a state in which the flying body 2 is connected thereto and in a state in which the traveling body 3 is detached from the flying body 2.

On the other hand, the flying body 2 is configured to fly along the airway in a state in which the flying body 2 is detached from the traveling body 3. Accordingly, compared to a case in which the flying body 2 integrated with the traveling body 3 flies along the airway, the flight range of the flying body 2 can be significantly extended. Further, the flying body 2 is able to substantially travel on the land route 6 by being connected to the traveling body 3. Therefore, it is advantageous that the flying body 2 be able to substantially travel on the land route 6 so that it can approach the user's destination as close as possible when, in particular, there is a limitation on places where the flying body 2 can take off from and land in, like in urban areas.

The outline of the next-generation transportation service provided in this embodiment is as follows.

The user requests for a vehicle dispatch of the next-generation taxi 1 via a terminal that he/she owns. Then the next-generation taxi 1 is dispatched to the user's current location. After the user gets on the next-generation taxi 1, the next-generation taxi 1 travels to the nearest takeoff and landing site. After the next-generation taxi 1 arrives at the takeoff and landing site, the flying body 2 is detached from the traveling body 3 and takes off. The flying body 2 flies to a takeoff and landing site that is the nearest to the user's destination. The traveling body 3 is deployed in the takeoff and landing site in advance, and the flying body 2 is landed as it is connected to the traveling body 3 that is deployed. The flying body 2 is connected to the traveling body 3, whereby the next-generation taxi 1 is re-configured. The next-generation taxi 1 travels to the user's destination. After the next-generation taxi 1 arrives at the destination, the user gets out of the next-generation taxi 1. This way, the user is able to get from the departure place to the destination while staying in the same flying body 2 without changing vehicles. Further, since the next-generation transportation service includes an airway in the moving path from the departure place to the destination, the user is able to move from the departure place to the destination in an extremely short period of time.

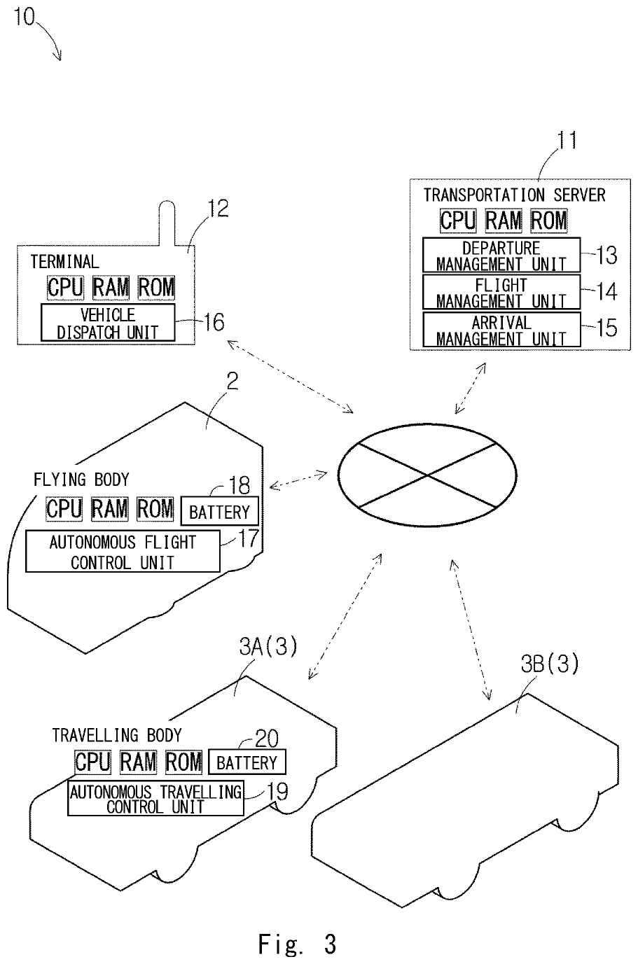

Next, with reference to FIG. 3, a transportation system 10 that achieves the next-generation transportation service will be described. As shown in FIG. 3, the transportation system 10 includes a transportation server 11 (transportation management server), at least one flying body 2, and at least one traveling body 3. The transportation system 10 may further include a terminal 12 which serves as a mobile terminal that the user uses. In this embodiment, at least one traveling body 3 includes traveling bodies 3A and 3B. The traveling body 3A is a traveling body 3 that is deployed near the user's departure place. The traveling body 3B is a traveling body 3 that is deployed near the user's destination.

The transportation server 11 includes a Central Processing Unit (CPU) which serves as a central processing device, a readable/writable Random Access Memory (RAM), and a Read Only Memory (ROM) that can be read only. Then the CPU loads a program stored in the ROM and executes the loaded program, whereby the program causes hardware such as the CPU to function as a departure management unit 13, a flight management unit 14, and an arrival management unit 15.

The terminal 12, which is typically a smartphone or a tablet, includes a CPU that serves as a central processing device, a readable/writable RAM, and a ROM that can be read only. Then the CPU loads a program stored in the ROM and executes the loaded program, whereby the program causes hardware such as the CPU to function as a vehicle dispatch unit 16.

The flying body 2 includes a Central Processing Unit (CPU) that serves as a central processing device, a readable/writable Random Access Memory (RAM), and a Read Only Memory (ROM) that can be read only. Then the CPU loads a program stored in the ROM and executes the loaded program, whereby the program causes hardware such as the CPU to function as an autonomous flight control unit 17. The flying body 2 further includes a battery 18 that can be charged. The autonomous flight control unit 17 drives a motor (not shown) by power supply from the battery 18, thereby causing the flying body 2 to autonomously fly. In this embodiment, the autonomous flight control unit 17 also serves as a communication unit that can communicate with the transportation server 11 bidirectionally.

The traveling body 3A includes a Central Processing Unit (CPU) that serves as a central processing device, a readable/writable Random Access Memory (RAM), and a Read Only Memory (ROM) that can be read only. Then the CPU loads a program stored in the ROM and executes the loaded program, whereby the program causes hardware such as the CPU to function as an autonomous traveling control unit 19. The traveling body 3A further includes a battery 20 that can be charged. The discharge capacity of the battery 20 is larger than the discharge capacity of the battery 18. The autonomous traveling control unit 19 autonomously travels the traveling body 3A by driving a motor (not shown) by power supply from the battery 20. In this embodiment, the autonomous traveling control unit 19 also serves as a communication unit that can communicate with the transportation server 11 bidirectionally.

Since the traveling body 3B has a configuration the same as that of the traveling body 3A, the descriptions thereof will be omitted.

Note that the traveling body 3 may be equipped with a power generator that uses fossil fuel, hydrogen fuel, or sunlight. The traveling body 3 may charge the battery 20 using the power generator. The autonomous traveling control unit 19 may move the traveling body 3 by driving a motor (not shown) by power supply from the power generator.

### (Terminal 12)

The vehicle dispatch unit 16 transmits vehicle dispatch request information to the transportation server 11. The vehicle dispatch request information includes information on the user's departure place and the user's destination. The vehicle dispatch request information may further include one or more of the scheduled departure time, the desired arrival time, the terminal ID, the user ID, and the payment method. The departure place may be the current position of the terminal 12 or the site specified by input from the user. The vehicle dispatch unit 16 may acquire the current position of the terminal 12 using a GPS receiver included in the terminal 12.

### (Transportation Server 11)

The departure management unit 13 manages a departure phase of the next-generation transportation system based on the vehicle dispatch request information received from the terminal 12. The departure phase is a phase from when the transportation server 11 has received the vehicle dispatch request information from the terminal 12 to when the flying body 2 takes off.

The flight management unit 14 manages a flight phase of the next-generation transportation system based on the vehicle dispatch request information received from the terminal 12. The flight phase is a phase from when the flying body 2 takes off to when it lands.

The arrival management unit 15 manages an arrival phase of the next-generation transportation system based on the vehicle dispatch request information received from the terminal 12. The arrival phase is a phase from when the flying body 2 lands to when the user arrives at the destination.

### (Flying Body 2)

The autonomous flight control unit 17 controls the autonomous flying of the flying body 2. The autonomous flight control unit 17 controls the autonomous flying of the flying body 2 based on flight command information from the flight management unit 14. The flight command information at least includes the takeoff and landing site at which the flying body 2 lands. The flight command information may include a flight route of the flying body 2, a flight speed of the flying body 2, a flight attitude of the flying body 2, and current or future weather conditions. The flight command information may further include a flight route, a flight speed, a flight attitude, or a current location of another flying body that may interfere with the flying body 2 on the flight route.

### (Traveling Body 3A)

The autonomous traveling control unit 19 controls the autonomous traveling of the traveling body 3A. The autonomous traveling control unit 19 controls the autonomous traveling of the traveling body 3A based on traveling command information from the departure management unit 13 or the arrival management unit 15. The traveling command information at least includes the departure place and the destination of the traveling body 3A. The traveling command information may include the traveling route of the traveling body 3A. The autonomous traveling control unit 19 may generate an optimal traveling route of the traveling body 3A based on the traveling command information.

The transportation server 11, the terminal 12, the flying body 2, and each of the traveling bodies 3 are able to communicate with one another via, for example, the Internet.

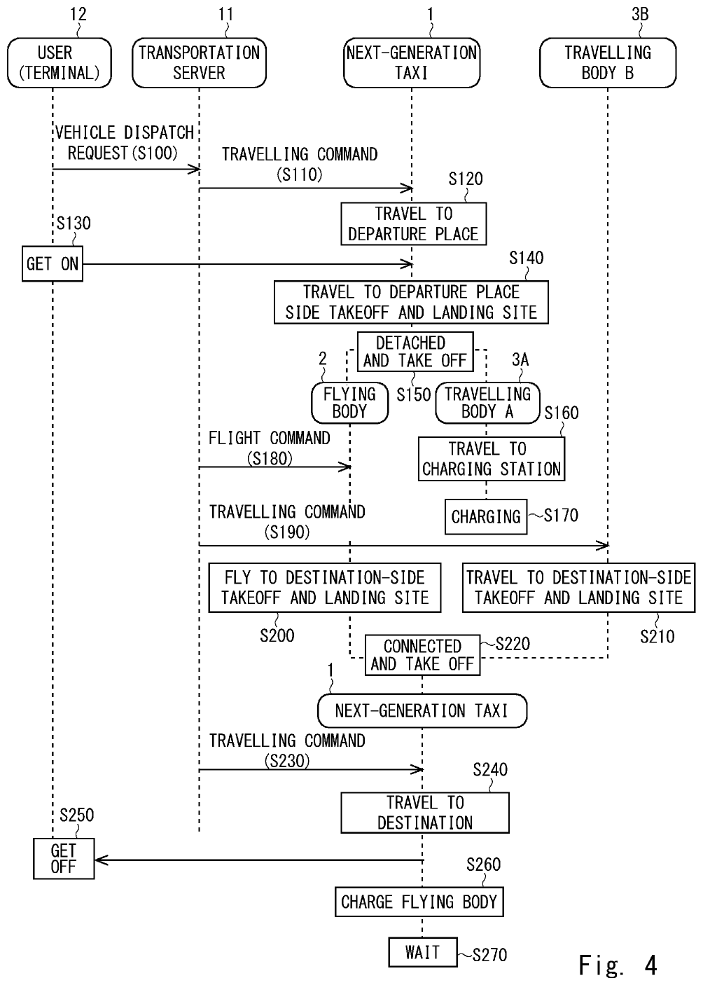

Referring next to FIG. 4, a control flow of the transportation system 10 will be described.

First, when the user uses the next-generation transportation service, the user starts a vehicle dispatch application installed in the terminal 12 in advance and inputs the departure place and the destination on the vehicle dispatch application. The user may specify the current location as the departure place or specify a desired site as the departure place. Then the terminal 12 transmits the vehicle dispatch request information to the transportation server 11 (S100).

Upon receiving the vehicle dispatch request information, the departure management unit 13 refers to map information stored in the ROM to search for and specify the takeoff and landing site that is the closest to the user's departure place. Further, the departure management unit 13 searches for and determines the traveling route from the user's departure place to the takeoff and landing site specified as above. Then the departure management unit 13 transmits the traveling command information to the next-generation taxi 1 (S110). The traveling command information includes information on the user's departure place and the above specified takeoff and landing site. The above specified takeoff and landing site, which is a takeoff and landing site where the flying body 2 is planned to take off, is a takeoff and landing site on the departure place side. The takeoff and landing site on the departure place side is hereinafter also referred to as a departure place side takeoff and landing site. The traveling command information may include the above determined traveling route.

The next-generation taxi 1 autonomously travels to the user's departure place by the autonomous control by the autonomous traveling control unit 19 based on the traveling command information (S120).

After the next-generation taxi 1 arrives at the user's departure place, the user gets on the next-generation taxi 1 (S130). Then the next-generation taxi 1 autonomously travels to the departure place side takeoff and landing site with the user on board by the autonomous control by the autonomous traveling control unit 19 based on the traveling command information (S140).

After the next-generation taxi 1 arrives at the departure place side takeoff and landing site, the flying body 2 is detached from the traveling body 3 and takes off with the user on board by the autonomous control by the autonomous flight control unit 17 (S150).

The traveling body 3A detached from the flying body 2 autonomously travels to the nearest charging station by the autonomous control by the autonomous traveling control unit 19 (S160), and executes charging of the battery 20 (S170).

On the other hand, the flight management unit 14 generates flight command information based on the vehicle dispatch request information and transmits the flight command information to the flying body 2 (S180). The flight command information includes information on a takeoff and landing site at which the flying body 2 lands, which is a takeoff and landing site on the destination side. The takeoff and landing site on the destination side is hereinafter also referred to as a destination-side takeoff and landing site. The flight management unit 14 typically determines the takeoff and landing site that is the closest to the destination that is included in the vehicle dispatch request information as the destination-side takeoff and landing site. However, in place of this, the flight management unit 14 may determine a takeoff and landing site that is included in the vehicle dispatch request information from which the user is able to get to the destination in the shortest period of time as the destination-side takeoff and landing site. Otherwise the flight management unit 14 may determine the destination-side takeoff and landing site in consideration of the weather in the destination or a road congestion state near the destination.

Further, the flight management unit 14 transmits the traveling command information to the traveling body 3B (S190). Specifically, the flight management unit 14 transmits the traveling command information to one of the plurality of traveling bodies 3 waiting near the destination-side takeoff and landing site. The flight management unit 14 may set the traveling body 3 that takes the shortest time to get to the destination-side takeoff and landing site among the plurality of traveling bodies 3 waiting near the destination-side takeoff and landing site as the traveling body 3B or set the traveling body 3 in which the discharge capacity of the battery 20 is the largest as the traveling body 3B. The traveling command information at least includes the destination of the traveling body 3B. It is assumed here that the destination of the traveling body 3B is the destination-side takeoff and landing site.

Then the flying body 2 autonomously flies to the destination-side takeoff and landing site by the autonomous control by the autonomous flight control unit 17 based on the flight command information (S200). Further, the traveling body 3B autonomously travels to the destination-side takeoff and landing site by the autonomous control by the autonomous traveling control unit 19 based on the traveling command information (S210). Preferably, the traveling body 3B autonomously travels to the destination-side takeoff and landing site in such a way that the traveling body 3B arrives at the destination-side takeoff and landing site before the flying body 2 arrives at the destination-side takeoff and landing site.

Then when the flying body 2 arrives at the destination-side takeoff and landing site, the flying body 2 is landed as it is connected to the traveling body 3B that has already waited at the destination-side takeoff and landing site, as shown in FIG. 2 (S220). Accordingly, the flying body 2 and the traveling body 3B re-configure the next-generation taxi 1.

Next, the arrival management unit 15 transmits the traveling command information to the next-generation taxi 1 (S230). The traveling command information at least includes the user's destination. The traveling command information may include the traveling route of the traveling body 3B. The autonomous traveling control unit 19 may generate the optimal traveling route of the traveling body 3B based on the traveling command information.

Then the next-generation taxi 1 autonomously travels to the user's destination by the autonomous control by the autonomous traveling control unit 19 based on the traveling command information (S240). After the next-generation taxi 1 arrives at the user's destination, the user gets out of the next-generation taxi 1 (S250). After that, the traveling body 3B charges the battery 18 of the flying body 2 connected to the traveling body 3B (S260) and waits until a new user appears (S270).

While the first embodiment has been described above, the aforementioned embodiment includes the following features.

The transportation system 10 includes the flying body 2 that can fly along the airway and that can be boarded by the user (person who is to be transported), the traveling body 3 that can travel on the land route 6 and can be connected to the flying body 2, and the transportation server 11 (transportation management server) that can communicate with the flying body 2 and the traveling body 3. The traveling body 3 is configured to be able to travel on the land route 6 in a state in which the flying body 2 is connected thereto and in a state in which it is detached from the flying body 2. The flying body 2 is configured to fly along the airway in the state in which it is detached from the traveling body 3. The flight management unit 14 (flight information acquiring unit) generates and acquires the flight command information (flight information) including the destination-side takeoff and landing site (the planned landing place of the flying body 2). The flight management unit 14 (planned landing place vehicle dispatch unit) dispatches, to the destination-side takeoff and landing site, the traveling body 3 to which the flying body 2 is not connected (S190). According to the above configuration, the flight range of the flying body 2 in the airway can be increased.

The departure management unit 13 (departure information acquisition unit) acquires the vehicle dispatch request information (departure information) including the user's departure place. The departure management unit 13 (departure place vehicle dispatch unit) dispatches, to the user's departure place, the traveling body 3 to which the flying body 2 is connected. According to the above configuration, the user is able to get on the flying body 2 without changing vehicles.

The traveling body 3 travels from the departure place to the departure place side takeoff and landing site (planned takeoff place of the flying body 2) in a state in which the flying body 2 is connected to the traveling body 3 (S140). According to the above configuration, the traveling body 3 is able to travel to a suitable planned takeoff place.

The traveling body 3 travels from the destination-side takeoff and landing site (planned landing place) to the user's destination in a state in which the flying body 2 is connected thereto (S240). According to the above configuration, the user is able to arrive at the destination without changing vehicles.

Further, the flying body 2 includes the connecting unit 2a that can be connected to the traveling body 3 capable of traveling on the land route and communicating with the transportation server 11 (transportation management server), and the autonomous flight control unit 17 (communication unit) that can communicate with the transportation server 11. The flying body 2 is able to fly along the airway with the user (person who is to be transported) on board. The autonomous flight control unit 17 may transmit the planned landing place where the flying body 2 is planned to land after the flight in the state in which it is not connected to the traveling body 3 to the transportation server 11. The connecting unit 2a may be connected to the traveling body 3 after the flight to the planned landing place.

Further, the traveling body 3 can be connected to the flying body 2. The flying body 2 can communicate with the transportation server 11 (transportation management server) and can fly along the airway with the user (person who is to be transported) on board. The traveling body 3 is able to travel on the land route in a state in which the flying body 2 is connected thereto and in a state in which it is detached from the flying body 2. The traveling body 3 may include the autonomous traveling control unit 19 (communication unit) capable of communicating with the transportation server 11. The traveling body 3 may further include a control unit configured to control traveling of the traveling body 3 based on the flight information from the autonomous traveling control unit 19. In this embodiment, the autonomous traveling control unit 19 may also serve as this control unit. The flight information includes information on the planned landing place where the flying body 2 detached from the traveling body 3 is planned to land. The autonomous traveling control unit 19 may acquire the flight information from the transportation server 11. The autonomous traveling control unit 19 may move the traveling body 3 to the planned landing place based on the flight information.

### Second Embodiment

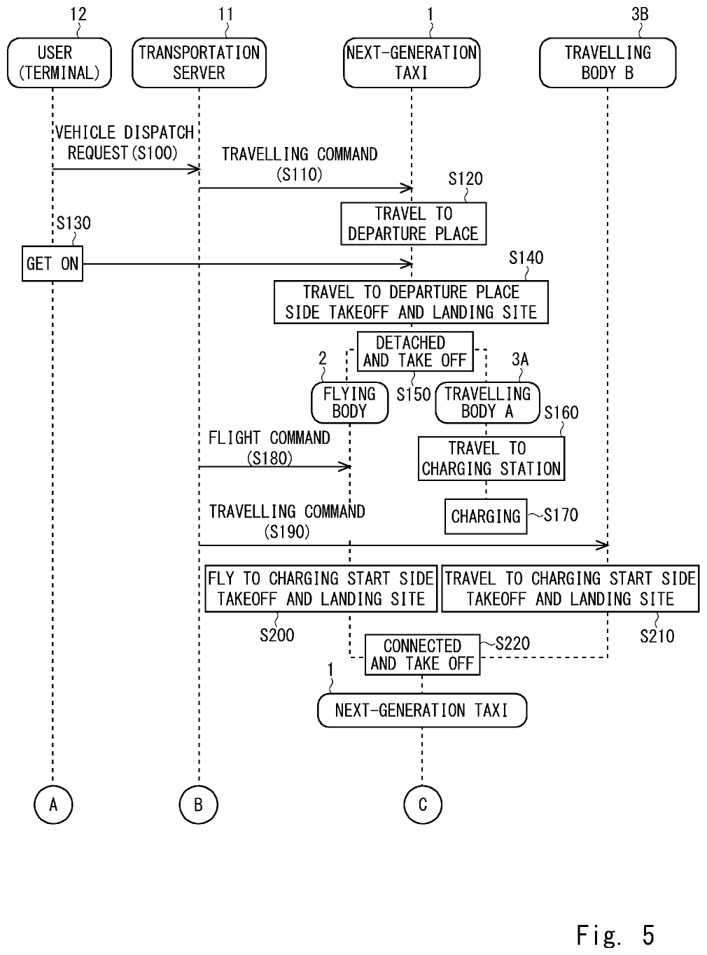

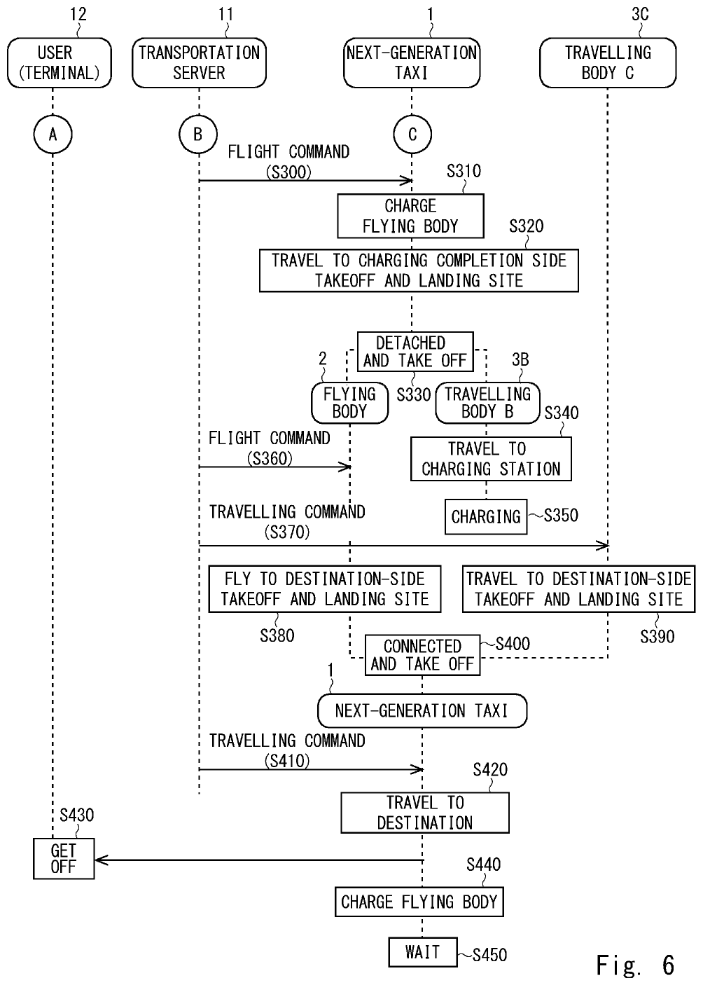

Referring next to FIGS. 5 and 6, a second embodiment according to the present disclosure will be described. In the following description, the points in this embodiment that are different from those in the above first embodiment will be mainly described and the overlapping descriptions will be omitted.

The outline of a next-generation transportation service provided in this embodiment is as follows.

In this embodiment, when the flying body 2 flies from the departure place side takeoff and landing site to the destination-side takeoff and landing site, the flying body 2 temporarily lands in the middle of the airway and is connected to the traveling body 3 to charge the battery 18 of the flying body 2. After the charging, the flying body 2 is detached from the traveling body 3, takes off, and re-starts flying toward the destination-side takeoff and landing site. Accordingly, the flight range of the flying body 2 in the airway can be substantially extended.

Accordingly, in this embodiment, at least one traveling body 3 includes traveling bodies 3A, 3B, and 3C. The traveling body 3A is a traveling body 3 deployed near the user's departure place. The traveling body 3B is a traveling body 3 that is deployed near the user's destination. The traveling body 3C, which is a traveling body 3 deployed in a desired place between the user's departure place and the destination, serves to charge the battery 18 of the flying body 2 in this embodiment.

Referring next to FIGS. 5 and 6, a control flow of the transportation system 10 will be described. However, since Step S100 to Step S170 in FIG. 5 are the same as those in the first embodiment, the descriptions thereof will be omitted.

The flight management unit 14 transmits the flight command information to the flying body 2 (S180). The flight command information at least includes a takeoff and landing site where the flying body 2 temporarily lands for charging. Hereinafter, the takeoff and landing site where the flying body 2 temporarily lands for charging is also referred to as a charging start side takeoff and landing site.

Further, the flight management unit 14 transmits the traveling command information to the traveling body 3B (S190). Specifically, the flight management unit 14 transmits the traveling command information to one of the plurality of traveling bodies 3 that are waiting near the charging start side takeoff and landing site. The flight management unit 14 may set the traveling body 3 that takes the shortest time to get to the charging start side takeoff and landing site among the plurality of traveling bodies 3 that are waiting near the charging start side takeoff and landing site as the traveling body 3B or may set the traveling body 3 in which the discharge capacity of the battery 20 is the largest as the traveling body 3B. The traveling command information at least includes information on the destination of the traveling body 3B. It is assumed that the destination of the traveling body 3B is the charging start side takeoff and landing site.

Then the flying body 2 autonomously flies to the charging start side takeoff and landing site by the autonomous control by the autonomous flight control unit 17 based on the flight command information (S200). Further, the traveling body 3B autonomously travels to the charging start side takeoff and landing site by the autonomous control by the autonomous traveling control unit 19 based on the traveling command information (S210).

When the flying body 2 arrives at the charging start side takeoff and landing site, the flying body 2 is landed as it is connected to the traveling body 3B that has already waited at the charging start side takeoff and landing site, as shown in FIG. 2 (S220). Accordingly, the flying body 2 and the traveling body 3B re-configure the next-generation taxi 1.

Referring next to FIG. 6, the arrival management unit 15 transmits the traveling command information to the next-generation taxi 1 (S300). The traveling command information at least includes information on the takeoff and landing site where the flying body 2 takes off after being charged. In the following description, the takeoff and landing site where the flying body 2 takes off after being charged is also referred to as a charging completion side takeoff and landing site. The charging completion side takeoff and landing site is closer to the user's destination than the charging start side takeoff and landing site is. However, the charging completion side takeoff and landing site may be a takeoff and landing site that is the same as the charging start side takeoff and landing site.

Next, the next-generation taxi 1 may autonomously travel to the charging completion side takeoff and landing site (S320) by the autonomous control by the autonomous traveling control unit 19 based on the traveling command information while charging the battery 18 of the flying body 2 using the battery 20 of the traveling body 3B (S310).

After the next-generation taxi 1 arrives at the charging completion side takeoff and landing site, the flying body 2 is detached from the traveling body 3B and takes off with the user on board by the autonomous control by the autonomous flight control unit 17 (S330).

The traveling body 3B detached from the flying body 2 autonomously travels to the nearest charging station (S340), and executes charging of the battery 20 (S350).

On the other hand, the flight management unit 14 generates the flight command information based on the vehicle dispatch request information and transmits the flight command information to the flying body 2 (S360). The flight command information at least includes information on the destination-side takeoff and landing site.

Further, the flight management unit 14 transmits the traveling command information to the traveling body 3C (S370). Specifically, the flight management unit 14 transmits the traveling command information to one of the plurality of traveling bodies 3 waiting near the destination-side takeoff and landing site. The flight management unit 14 may set the traveling body 3 that takes the shortest time to get to the destination-side takeoff and landing site among the plurality of traveling bodies 3 waiting near the destination-side takeoff and landing site as the traveling body 3C or set the traveling body 3 in which the discharge capacity of the battery 20 is the largest as the traveling body 3C. The traveling command information at least includes the destination of the traveling body 3C. It is assumed that the destination of the traveling body 3C is the destination-side takeoff and landing site.

Then the flying body 2 autonomously flies to the destination-side takeoff and landing site by the autonomous control by the autonomous flight control unit 17 based on the flight command information (S380). Further, the traveling body 3C autonomously travels to the destination-side takeoff and landing site by the autonomous control by the autonomous traveling control unit 19 based on the traveling command information (S390). Preferably, the traveling body 3C autonomously travels to the destination-side takeoff and landing site in such a way that the traveling body 3C arrives at the destination-side takeoff and landing site before the flying body 2 arrives at the destination-side takeoff and landing site.

When the flying body 2 arrives at the destination-side takeoff and landing site, the flying body 2 is landed as it is connected to the traveling body 3C that has already waited at the destination-side takeoff and landing site, as shown in FIG. 2 (S400). Accordingly, the flying body 2 and the traveling body 3C re-configure the next-generation taxi 1.

Next, the arrival management unit 15 transmits the traveling command information to the next-generation taxi 1 (S410). The traveling command information at least includes information on the user's destination. The traveling command information may include information on the traveling route of the traveling body 3C. The autonomous traveling control unit 19 may generate the optimal traveling route of the traveling body 3C based on the traveling command information.

Then the next-generation taxi 1 autonomously travels to the user's destination by the autonomous control by the autonomous traveling control unit 19 based on the traveling command information (S420). After the next-generation taxi 1 arrives at the user's destination, the user gets out of the next-generation taxi 1 (S430). After that, the traveling body 3C charges the battery 18 of the flying body 2 connected to the traveling body 3C (S440) and waits for a new user to appear (S450).

While the second embodiment has been described above, the aforementioned embodiment includes the following features.

The flying body 2 is configured to be driven by the battery 18 that can be charged. The traveling body 3 is configured to be able to charge the battery 18 of the flying body 2 in a state in which the traveling body 3 is connected to the flying body 2. The flight command information (flight information) includes a temporary destination side takeoff and landing site (planned temporary landing place) where the flying body 2 temporarily lands in order to charge the battery 18 of the flying body 2. The temporary destination side takeoff and landing site is a site between the user's departure place and the destination-side takeoff and landing site. The flight management unit 14 (planned temporary landing place vehicle dispatch unit) further dispatches, to the temporary destination side takeoff and landing site, the traveling body 3 to which the flying body 2 is not connected. According to the above configuration, the flight range of the flying body 2 can be substantially extended.

Further, the traveling body 3 travels from the planned temporary landing place vehicle dispatch unit toward the user's destination while charging the battery 18 of the flying body 2. The above configuration allows the traveling body 3 to approach the user's destination using the charging time, whereby the user's travel time can be reduced.

In each of the embodiments described above, a natural person or a legal person may own the flying body 2 alone or in collaboration with another natural person or another legal person. The plurality of traveling bodies 3 may be owned by a service provider or may be lent to a natural person or a legal person as necessary. However, a natural person or a legal person may own the plurality of traveling bodies 3 alone or in collaboration with another natural person or another legal person.

In the aforementioned examples, the program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks). Examples of non-transitory computer readable media further include CD-Read Only Memory (ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A transportation system comprising:
a flying body that can fly along an airway and can be boarded by a person who is to be transported;
a traveling body that can travel on a land route and can be connected to the flying body; and
a transportation management server that can communicate with the flying body and the traveling body, wherein
the traveling body is configured to be able to travel on the land route in a state in which the flying body is connected to the traveling body and in a state in which the traveling body is detached from the flying body,
the flying body is configured to fly along the airway in the state in which it is detached from the traveling body, and
the transportation management server comprises:
a flight information acquiring unit configured to acquire flight information including a planned landing place of the flying body; and
a planned landing place vehicle dispatch unit configured to dispatch, to the planned landing place, the traveling body to which the flying body is not connected.

2. The transportation system according to claim 1, wherein the transportation management server further comprises:
a departure information acquisition unit configured to acquire departure information including information on a departure place of the person who is to be transported; and
a departure place vehicle dispatch unit configured to dispatch, to the departure place, the traveling body to which the flying body is connected.

3. The transportation system according to claim 2, wherein the traveling body travels from the departure place to a planned takeoff place of the flying body in the state in which the flying body is connected to the traveling body.

4. The transportation system according to claim 1, wherein the traveling body travels from the planned landing place to the destination of the person who is to be transported in the state in which the flying body is connected to the traveling body.

5. The transportation system according to claim 1, wherein the traveling body is able to autonomously travel on the land route.

6. The transportation system according to claim 1, wherein the flying body is able to autonomously fly along the airway.

7. The transportation system according to claim 1,
the flying body is configured in such a way that it is driven by a battery that can be charged,
the traveling body is configured to be able to charge the battery of the flying body in a state in which the traveling body is connected to the flying body,
the flight information includes information on a planned temporary landing place where the flying body temporarily lands in order to charge the battery of the flying body,
the planned temporary landing place is a place between the departure place of the person who is to be transported and the planned landing place, and
the transportation system further includes a planned temporary landing place vehicle dispatch unit configured to dispatch, to the planned temporary landing place, the traveling body to which the flying body is not connected.

8. The transportation system according to claim 7, wherein the traveling body travels from the planned temporary landing place to the destination of the person who is to be transported while charging the battery of the flying body.

9. A transportation management server that can communicate with a flying body that can fly along an airway and that can be boarded by a person who is to be transported and a traveling body that can travel on a land route and that can be connected to the flying body, wherein
the traveling body is configured to be able to travel on the land route in a state in which the flying body is connected to the traveling body and in a state in which the traveling body is detached from the flying body,
the flying body is configured to fly along the airway in the state in which it is detached from the traveling body,
the transportation management server comprises a flight information acquiring unit configured to acquire flight information including a planned landing place of the flying body, and
the transportation management server comprises a planned landing place vehicle dispatch unit configured to dispatch, to the planned landing place, the traveling body to which the flying body is not connected.

10. A flying body comprising a connecting unit that can be connected to a traveling body capable of traveling on a land route and communicating with a transportation management server and a communication unit that can communicate with the transportation management server, the flying body being able to fly along an airway with a person who is to be transported on board, wherein
the communication unit transmits, to the transportation management server, a planned landing place where the flying body is planned to land after the flight in a state in which it is not connected to the traveling body, and
the connecting unit is connected to the traveling body after the flight to the planned landing place.

11. A traveling body that can be connected to a flying body capable of communicating with a transportation management server and flying along an airway with a person who is to be transported on board, the traveling body being capable of traveling on a land route in a state in which the flying body is connected to the traveling body and in a state in which the traveling body is detached from the flying body, and the traveling body comprising a communication unit that can communicate with the transportation management server, wherein
the traveling body further comprises a control unit configured to control traveling of the traveling body based on flight information from the communication unit,
the flight information comprises information on a planned landing place where the flying body detached from the traveling body is planned to land,
the communication unit acquires the flight information from the transportation management server, and
the control unit causes the traveling body to travel to the planned landing place based on the flight information.
